(19) United States
(12) Patent Application Publication
(10) Pub. No.: US 2017/0104663 A1
(43) Pub. Date: Apr. 13, 2017

(54) METHODS AND SYSTEMS FOR MONITORING RESOURCES OF A NETWORKED STORAGE ENVIRONMENT

(71) Applicant: NETAPP, INC., Sunnyvale, CA (US)

(72) Inventor: Abhi Basu Thakur, Bangalore (IN)

(73) Assignee: NETAPP, INC., Sunnyvale, CA (US)

(21) Appl. No.: 14/881,467

(22) Filed: Oct. 13, 2015

(51) Int. Cl. H04L 12/26; G06F 3/06

(52) U.S. Cl. CPC H04L 43/16; G06F 3/0665; G06F 3/0613; G06F 3/067; H04L 43/0888

(57) ABSTRACT

Methods and systems for a networked storage environment are provided. One method includes monitoring at a time interval a plurality of resources of a cluster of the networked storage environment having a plurality of nodes and storage devices for storing data on behalf of a plurality of users, where a processor of a management console monitors the plurality of resources; retrieving performance data of a storage volume presented by one of the nodes of the cluster; comparing the performance data with a threshold value to determine whether resources associated with the storage volume are being used; increasing the time interval for monitoring the associated resources when the performance data continues to be consistently below the threshold value for a certain duration; and decreasing the time interval for monitoring the associated resources when the performance data continues to be consistently above the threshold value for a certain duration.

### TECHNICAL FIELD

The present disclosure relates to monitoring resources in a networked storage environment.

### BACKGROUND

Various forms of storage systems are used today. These forms include direct attached storage (DAS) network attached storage (NAS) systems, storage area networks (SANs), and others. Network storage systems are commonly used for a variety of purposes, such as providing multiple clients with access to shared data, backing up data and others.

A storage system typically includes at least a computing system executing a storage operating system for storing and retrieving data on behalf of one or more client computing systems (may just be referred to as “client” or “clients”). The storage operating system stores and manages shared data containers in a set of mass storage devices.

To read and/or write data, various resources are used within a storage system, for example, network resources (switches, network adapters and others), processors, storage devices and others. As storage systems continue to expand in size and operating speeds, it is desirable to monitor resource usage within storage systems. However, because storage systems use numerous resources for a plurality of clients, monitoring the resources, typically uses computing power at a management console. Continuous efforts are being made to efficiently monitor resources in a networked storage environment.

### BRIEF DESCRIPTION OF THE DRAWINGS

The various features of the present disclosure will now be described with reference to the drawings of the various aspects. In the drawings, the same components may have the same reference numerals. The illustrated aspects are intended to illustrate, but not to limit the present disclosure. The drawings include the following Figures:

FIG. 1 shows an example of a networked storage operating environment for the various aspects disclosed herein;

FIG. 2A shows an example of a networked clustered storage system, used according to one aspect of the present disclosure;

FIG. 2B shows an example of a management console, according to one aspect of the present disclosure;

FIG. 3 shows an example of a process for collecting performance data, according to one aspect of the present disclosure;

FIG. 4 shows an example of a storage system node, used according to one aspect of the present disclosure;

FIG. 5 shows an example of a storage operating system, used according to one aspect of the present disclosure in a networked storage environment; and

FIG. 6 shows an example of a processing system, used according to one aspect of the present disclosure in the networked storage environment.

### DETAILED DESCRIPTION

As a preliminary note, the terms “component”, “module”, “system,” and the like as used herein are intended to refer to a computer-related entity, either software-executing general purpose processor, hardware, firmware and a combination thereof. For example, a component may be, but is not limited to being, a process running on a hardware processor, a hardware based processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, at non-transitory, computer readable media including, but not limited to, an ASIC (application specific integrated circuit), CD (compact disc), DVD (digital video disk), ROM (read only memory), floppy disk, hard disk, EEPROM (electrically erasable programmable read only memory), memory stick or any other storage device, in accordance with the claimed subject matter.

In one aspect, methods and systems for a networked storage environment are provided. One method includes monitoring at a time interval a plurality of resources of a cluster of the networked storage environment having a plurality of nodes and storage devices for storing data on behalf of a plurality of users, where a processor of a management console monitors the plurality of resources; retrieving performance data of a storage volume presented by one of the nodes of the cluster; comparing the performance data with a threshold value to determine whether resources associated with the storage volume are being used; increasing the time interval for monitoring the associated resources when the performance data continues to be consistently below the threshold value for a certain duration; and decreasing the time interval for monitoring the associated resources when the performance data continues to be consistently above or equal to the threshold value for a certain duration.

System 100:

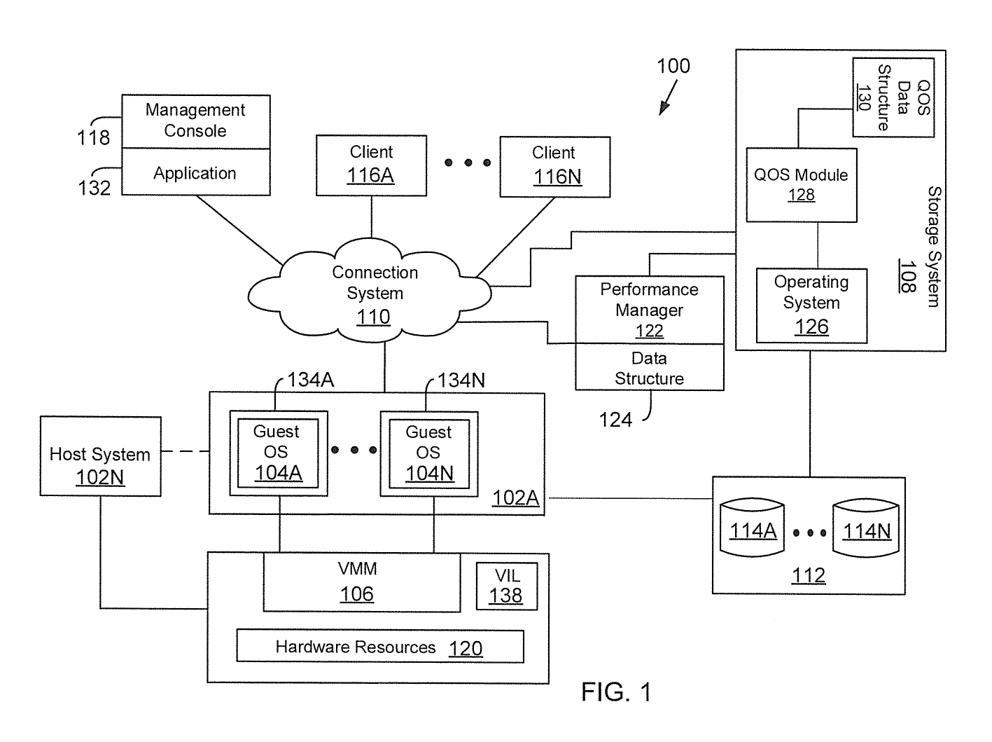

FIG. 1 shows an example of a system 100, where the adaptive aspects disclosed herein may be implemented. System 100 includes a management console 118 executing a hardware based, processor executable, management application 132 that monitors various resources used by a storage system 108. It is noteworthy that although a single management console 118 is shown in FIG. 1, system 100 may include other management consoles performing certain functions, for example, managing storage resources, managing network connections and other functions described below. Details regarding management application 132 are provided below.

Quality of Service (QOS) is used in a networked storage environment to provide certain throughput in processing input/output (I/O) requests for reading and writing data, a response time goal within, which I/O requests are processed and a number of I/O requests processed within a given time (for example, in a second (IOPS)). Throughput means an amount of data transferred within a given time in response to the I/O requests, for example, in megabytes per second (Mb/s). Different QOS levels may be provided to different clients depending on client service levels.

System 100 may also include a performance manager 122 that interfaces with a storage operating system 126 of a storage system 108 for receiving performance data (may also be referred to as QOS data) regarding different resources. The performance manager 122 obtains the QOS data and stores it at a local data structure 124. In one aspect, performance manager 122 provides the performance data to the management console 118, for example, the average number of IOPS within a certain duration for a storage volume. In another aspect, the management console 118 obtains the performance data directly from the storage system 108.

In one aspect, storage system 108 has access to a set of mass storage devices 114A-114N (may be referred to as storage devices 114 or simply as storage device 114) within at least one storage subsystem 112. The storage devices 114 may include writable storage device media such as magnetic disks, video tape, optical, DVD, magnetic tape, non-volatile memory devices for example, solid state drives (SSDs) including self-encrypting drives, flash memory devices and any other similar media adapted to store information. The storage devices 114 may be organized as one or more groups of Redundant Array of Independent (or Inexpensive) Disks (RAID). The aspects disclosed are not limited to any particular storage device type or storage device configuration.

In one aspect, the storage system 108 provides a set of logical storage volumes (may be interchangeably referred to as volume or storage volume) for providing physical storage space to clients 116A-116N (or virtual machines (VMs) 134A-134N). A storage volume is a logical storage object and typically includes a file system in a NAS environment or a logical unit number (LUN) in a SAN environment. The aspects described herein are not limited to any specific format in which physical storage is presented as logical storage (volume, LUNs and others)

Each storage volume may be configured to store data files (or data containers or data objects), scripts, word processing documents, executable programs, and any other type of structured or unstructured data. From the perspective of one of the client systems, each storage volume can appear to be a single drive. However, each storage volume can represent storage space in at one storage device, an aggregate of some or all of the storage space in multiple storage devices, a RAID group, or any other suitable set of storage space.

A storage volume is identified by a unique identifier (Volume-ID) and is allocated certain storage space during a configuration process. When the storage volume is created, a QOS policy may be associated with the storage volume such that requests associated with the storage volume can be managed appropriately. The QOS policy may be a part of a QOS policy group (referred to as “Policy_Group”) that is used to manage QOS for several different storage volumes as a single unit. The QOS policy information may be stored at a QOS data structure 130 maintained by a QOS module 128 and at the storage system level may be implemented by the QOS module 128. QOS module 128 maintains various QOS data types that are monitored and analyzed by the management console 118 and/or performance manager 122.

The storage operating system 126 organizes physical storage space at storage devices 114 as one or more “aggregate”, where each aggregate is a logical grouping of physical storage identified by a unique identifier and a location. The aggregate includes a certain amount of storage space that can be expanded. Within each aggregate, one or more storage volumes are created whose size can be varied. A qtree, sub-volume unit may also be created within the storage volumes. For QOS management, each aggregate and the storage devices within the aggregates are considered as resources that are used by storage volumes.

The storage system 108 may be used to store and manage information at storage devices 114 based on an I/O request. The request may be based on file-based access protocols, for example, the Common Internet File System (CIFS) protocol or Network File System (NFS) protocol, over the Transmission Control Protocol/Internet Protocol (TCP/IP). Alternatively, the request may use block-based access protocols, for example, the Small Computer Systems Interface (SCSI) protocol encapsulated over TCP (iSCSI) and SCSI encapsulated over Fibre Channel (FCP).

In a typical mode of operation, a client (or a VM) transmits one or more I/O request, such as a CFS or NFS read or write request, over a connection system 110 to the storage system 108. Storage operating system 126 receives the request, issues one or more I/O commands to storage devices 114 to read or write the data on behalf of the client system, and issues a CIFS or NFS response containing the requested data over the network 110 to the respective client system.

Optionally, system 100 may also include a virtual machine environment where a physical resource is time-shared among a plurality of independently operating processor executable VMs. Each VM may function as a self-contained platform, running its own operating system (OS) and computer executable, application software. The computer executable instructions running in a VM may be collectively referred to herein as “guest software.” In addition, resources available within the VM may be referred to herein as “guest resources.”

The guest software expects to operate as if it were running on a dedicated computer rather than in a VM. That is, the guest software expects to control various events and have access to hardware resources on a physical computing system (may also be referred to as a host platform or host system) which maybe referred to herein as “host hardware resources”. The host hardware resource may include one or more processors, resources resident on the processors (e.g., control registers, caches and others), memory (instructions residing in memory, e.g., descriptor tables), and other resources (e.g., input/output devices, host attached storage, network attached storage or other like storage) that reside in a physical machine or are coupled to the host system.

In one aspect, system 100 may include a plurality of computing systems 102A-102N (may also be referred to individually as host platform/system 102 or simply as server 102) communicably coupled to the storage system 108 executing via the connection system 110 such as a local area network (LAN), wide area network (WAN), the Internet or any other interconnect type. As described herein, the term “communicably coupled” may refer to a direct connection, a network connection, a wireless connection or other connections to enable communication between devices.

Host system 102A includes a processor executable virtual machine environment having a plurality of VMs 134A-134N that may be presented to client computing devices/systems 116A-116N. VMs 134A-134N execute a plurality of guest OS 104A-104N (may also be referred to as guest OS 104) that share hardware resources 120. As described above, hardware resources 120 may include processors, memory, I/O devices, storage or any other hardware resource.

In one aspect, host system 102A interfaces with a virtual machine monitor (VMM) 106, for example, a processor executed Hyper-V layer provided by Microsoft Corporation of Redmond, Wash., a hypervisor layer provided by VMWare Inc., or any other type. VMM 106 presents and manages the plurality of guest OS 104A-104N executed by the host system 102. The VMM 106 may include or interface with a virtualization layer (VIL) 138 that provides one or more virtualized hardware resource to each OS 104A-104N.

In one aspect, VMM 106 is executed by host system 102 with VMs 134A-134N. In another aspect, VMM 106 may be executed by an independent stand-alone computing system, often referred to as a hypervisor server or VMM server and VMs 134A-134N are presented at one or more computing systems.

It is noteworthy that different vendors provide different virtualization environments, for example, VMware Corporation, Microsoft Corporation and others. The generic virtualization environment described above with respect to FIG. 1 may be customized to implement the aspects of the present disclosure. Furthermore, VMM 106 (or VIL 138) may execute other modules, for example, a storage driver, network interface and others, the details of which are not germane to the aspects described herein and hence have not been described in detail.

In one aspect, storage space that is managed by storage system 108 is presented to clients' 116A-116N (or VMs). The clients may be grouped into different service levels, where a client with a higher service level may be provided with more storage space than a client with a lower service level. A client at a higher level may also be provided with a certain QOS vis-à-vis a client at a lower level.

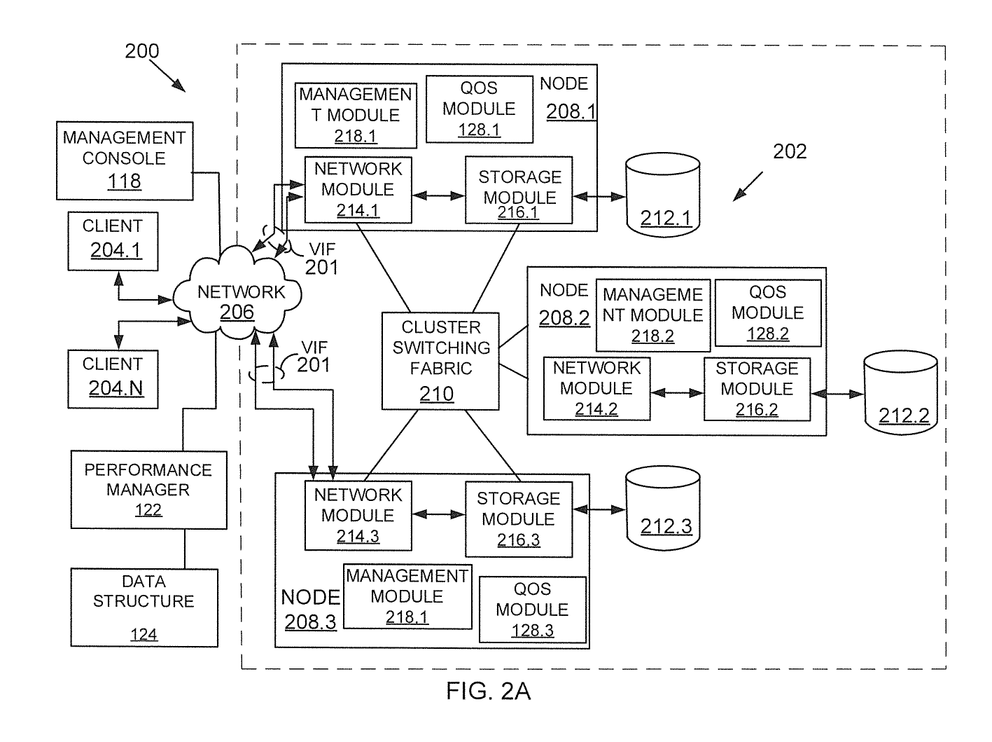

Although storage system 108 is shown as a stand-alone system, i.e. a non-cluster based system, in another aspect, storage system 108 may have a distributed architecture; for example, a cluster based system of FIG. 2A. Before describing the various aspects of the management application 132, the following first provides a description of a cluster based storage environment.

Clustered Storage System:

FIG. 2A shows a cluster based storage environment 200 having a plurality of nodes for managing storage devices, according to one aspect. Storage environment 200 may include a plurality of client systems 204.1-204.N (similar to clients 116A-116N, FIG. 1), a clustered storage system 202, performance manager 122, management console 118 and at least a network 206 communicably connecting the client systems 204.1-204.N and the clustered storage system 202.

The clustered storage system 202 includes a plurality of nodes 208.1-208.3, a cluster switching fabric 210, and a plurality of mass storage devices 212.1-212.3 (may be referred to as 212 and similar to storage device 114).

Each of the plurality of nodes 208.1-208.3 is configured to include a network module, a storage module, and a management module, each of which can be implemented as a hardware based, processor executable module. Specifically, node 208.1 includes a network module 214.1, a storage module 216.1, and a management module 218.1, node 208.2 includes a network module 214.2, a storage module 216.2, and a management module 218.2, and node 208.3 includes a network module 214.3, a storage module 216.3, and a management module 218.3.

The network modules 214.1-214.3 include functionality that enable the respective nodes 208.1-208.3 to connect to one or more of the client systems 204.1-204.N over the computer network 206, while the storage modules 216.1-216.3 connect to one or more of the storage devices 212.1-212.3. Accordingly, each of the plurality of nodes 208.1-208.3 in the clustered storage server arrangement provides the functionality of a storage server.

The management modules 218.1-218.3 provide management functions for the clustered storage system 202. The management modules 218.1-218.3 collect storage information regarding storage devices 212.

Each node may execute or interface with a QOS module, shown as 128.1-128.3 that is similar to the QOS module 128. The QOS modules are executed for each node or a single QOS module may be used for the entire cluster. The various aspects disclosed herein are not limited to the number of instances of QOS module 128 that may be used in a cluster.

A switched virtualization layer including a plurality of virtual interfaces (VIFs) 201 is provided to interface between the respective network modules 214.1-214.3 and the client systems 204.1-204.N, allowing storage 212.1-212.3 associated with the nodes 208.1-208.3 to be presented to the client systems 204.1-204.N as a single shared storage pool.

The clustered storage system 202 can be organized into any suitable number of virtual servers (also referred to as “vservers” or storage virtual machines), in which each vserver represents a single storage system namespace with separate network access. Each vserver has a client domain and a security domain that are separate from the client and security domains of other vservers. Moreover, each vserver is associated with one or more VIFs and can span one or more physical nodes, each of which can hold one or more VIFs and storage associated with one or more vservers. Client systems can access the data on a vserver from any node of the clustered system, through the VIFs associated with that vserver. It is noteworthy that the aspects described herein are not limited to the use of vservers.

Each of the nodes 208.1-208.3 is defined as a computing system to provide application services to one or more of the client systems 204.1-204.N. The nodes 208.1-208.3 are interconnected by the switching fabric 210, which, for example, may be embodied as a Gigabit Ethernet switch or any other type of switching/connecting device.

Although FIG. 2A depicts an equal number (i.e., 3) of the network modules 214.1-214.3, the storage modules 216.1-216.3, and the management modules 218.1-218.3, any other suitable number of network modules, storage modules, and management modules may be provided. There may also be different numbers of network modules, storage modules, and/or management modules within the clustered storage system 202. For example, in alternative aspects, the clustered storage system 202 may include a plurality of network modules and a plurality of storage modules interconnected in a configuration that does not reflect a one-to-one correspondence between the network modules and storage modules.

Each client system 204.1-204.N may request the services of one of the respective nodes 208.1, 208.2, 208.3, and that node may return the results of the services requested by the client system by exchanging packets over the computer network 206, which may be wire-based, optical fiber, wireless, or any other suitable combination thereof.

In a typical data center, storage servers are used by various clients/users. The users are normally geographically spread out. For example, a data center using the storage system nodes may be in any country. Because the storage system nodes are spread out, not all of them may be used at the same time.

In conventional systems, typical management consoles monitor storage system resources at fixed time intervals. Typically, management consoles poll storage systems for performance data, regardless of whether a storage system or a cluster node/storage devices are being actively used. Polling storage system resources uses computing resources because a management console obtains data regarding vservers, storage volumes, CIFS shares, LUNs, storage device utilization, snapshot data, data regarding network adapters and devices and others. Polling one or more nodes that is not being actively used wastes computing resources and time. This challenge is further magnified when one management console monitors multiple clusters having a plurality of nodes. In such an environment, typical management consoles are not able to efficiently monitor the various resources.

In one aspect, this disclosure provides management console 118 that executes a monitoring process where a polling frequency by the management console 118 is adjusted based on the usage of a storage system resource. For example, a polling frequency is reduced when the storage system is being used less and the polling frequency is increased when the storage system is used more. In one aspect, different metrics may be used to ascertain storage system “use”. One metric may be the number of IOPS that are processed for a storage volume within a certain duration. If the number of IOPS are low, then the polling frequency is decreased. If the number of IOPs is high, the polling frequency is adjusted accordingly.

In another aspect, nodes within one or more clusters in a data center are configured based on time zones/geographical access. For example, if a data center is located in the US with multiple cluster nodes, then certain nodes may be allocated for a particular time zone (for example, access from US customers) and others may be allocated for another time zone (for example, access from Indian users). This will simplify monitoring because Indian users are likely to access the storage system nodes at a different time than US users due to the time difference between the geographical zones. Thus, the management console 118 monitoring frequency can be adjusted based on the time zones and frequency of usage. Details regarding selective monitoring by the management console 118 is provided below.

Management Console 118:

FIG. 2B shows an example management console 118 executing various components of management application 132. In one aspect, management console 118 includes a communication interface 220 that communicates with the performance manager 122 and storage system 202. The communication interface 220 includes logic and circuitry for network communications. In one aspect, Ethernet or any other protocol may be used for network communication.

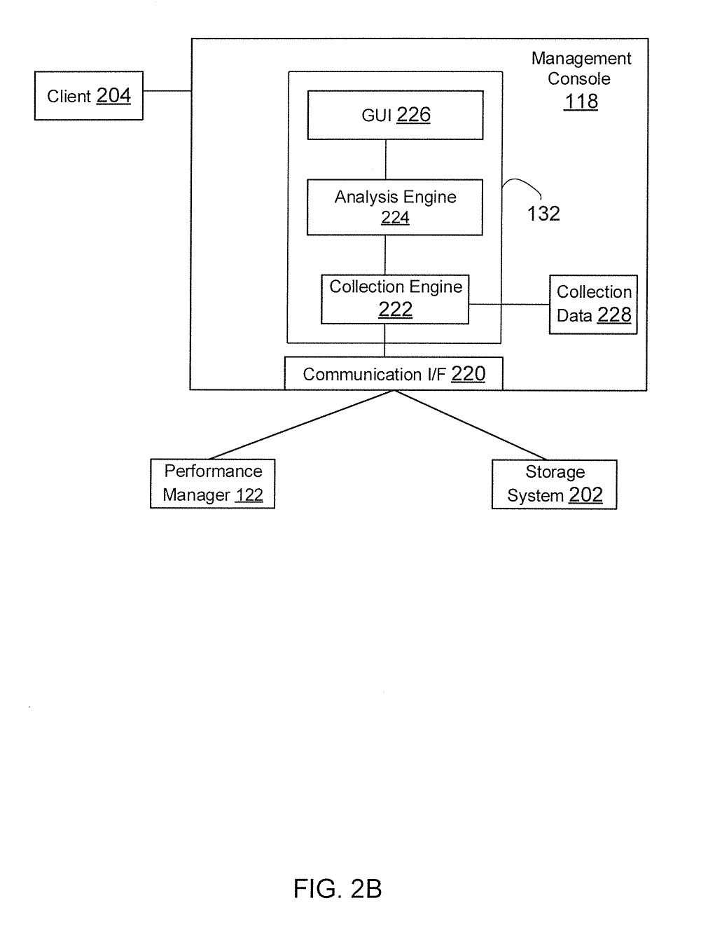

The management application 132 includes a collection engine 222 that collects data 228. The collected data may be the number of IOPS for a storage volume, storage device or an aggregate. The collected data 228 may also include latency information i.e. delay in processing I/O requests as well as storage device utilization. The collection engine 222 includes logic to determine how often data is to be collected as described below with respect to FIG. 3.

The management application 132 may also include an analysis engine 224 that analyses collected 228 and provides access to the information via a graphical user interface (GUI) 226. The analysis may be used to trigger events based on monitored data. In one aspect GUI 226 is provided for adjusting threshold values for adjusting monitoring frequency, as described below with respect to FIG. 3.

Process Flow:

FIG. 3 shows a process 300 for monitoring various resources of storage system 202, according to one aspect of the present disclosure. The process begins in block B302, when storage system 202 cluster nodes, clients and management console 118 are initialized and operational.

In block B304, resource monitoring for one or more clusters is initiated based on a first time interval. The time interval may be configurable and may be every hour, 30 minutes or any other interval. The monitoring process involves obtaining information regarding the vservers, growth of storage volumes, amount of space consumed by storage volumes, amount of space remaining for storage volumes. The storage system nodes maintain this information using various counters. The monitoring process further includes obtaining information regarding CIFS shares (data growth, consumed, remaining), LUNs, storage device utilization, snapshot (i.e. a point in time copy of a storage volume) information i.e. number of snapshots that may have been taken, that need to be taken and others. The monitoring in block B304 further includes obtaining information regarding replication i.e. when data from one cluster is transferred to another cluster for disaster recovery. The monitoring process may further include obtaining throughput at various adapters that are used by the cluster nodes to communicate with the storage devices. The management application 132 uses firmware and hardware resources (for example, a network interface adapter) to obtain this information from the cluster nodes and/or performance manager 122. The management application 132 may use network protocols for example, Ethernet or any other protocol to obtain the information. In one aspect, various application programming interface (APIs) may be used to automatically retrieve the information within the defined time interval. As one can see, monitoring these various aspects for multiple resources is time consuming and uses computing resources.

In block B306, performance data is retrieved for a storage volume that uses storage space within a cluster. In one aspect, the performance data for the storage volume is retrieved from the performance manager 122 or directly from the storage system nodes. The performance data may be obtained by generating a query and providing a storage volume identifier either to the storage system 108 or the performance manager 122.

In block B308, the collected performance data is compared with a threshold value. For example, performance data may be the number of IOPS and the number of IOPS are compared to a value X, for example, 5. If the threshold value is reached i.e. greater than or equal to X, then the management application 132 continues to monitor the performance data for a certain duration to ensure that the performance data value is not an anomaly. If the performance data still reflects high activity for the storage volume, then the monitoring interval for monitoring the storage resources associated with the storage volume is decreased.

If the performance data is below the threshold value indicating low activity/access to resources, then the management application 132 continues to monitor the storage volume for a certain duration to ensure that the low activity indicator is not an anomaly. If the activity level continues to be low, then the monitoring interval is increased such that inactive resources are not monitored. This optimizes computing resources of the management console 118.

The process described above allows the management console 118 to scale i.e. monitor more clusters because it is uses an adaptive technique to monitor resources.

Storage System Node:

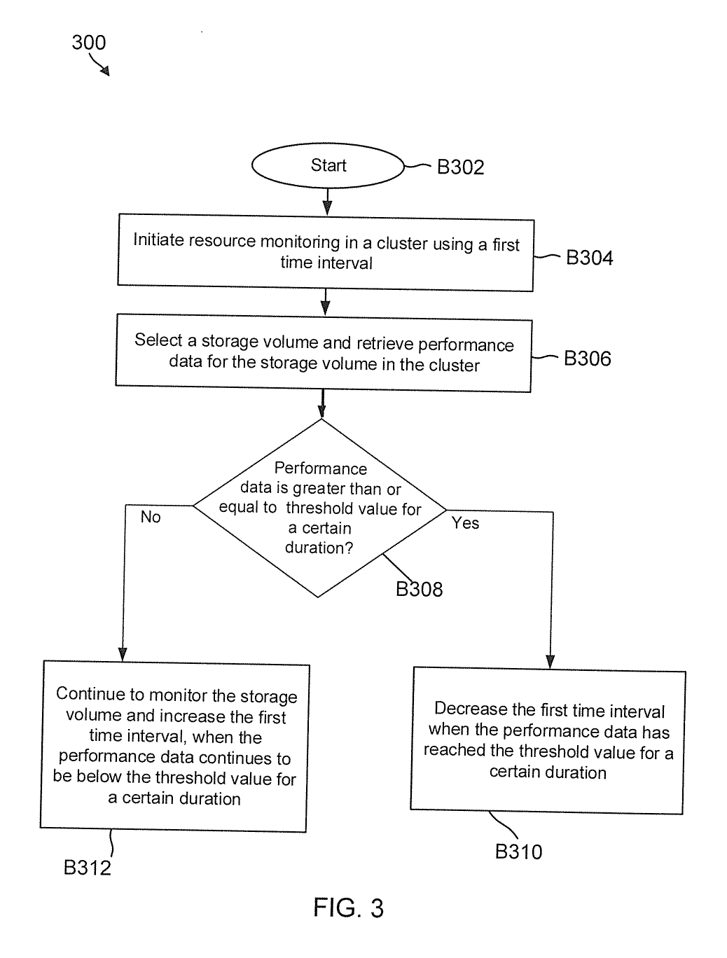

FIG. 4 is a block diagram of a node 208.1 that is illustratively embodied as a storage system comprising of a plurality of processors 402A and 402B, a memory 404, a network adapter 410, a cluster access adapter 412, a storage adapter 416 and local storage 717 interconnected by a system bus 408. Node 208.1 may be used to provide performance data to performance manager 122 and/or management console 118 described above during the monitoring step of B304 of FIG. 3.

Processors 402A-402B may be, or may include, one or more programmable general-purpose or special-purpose microprocessors, digital signal processors (DSPs), programmable controllers, application specific integrated circuits (ASICs), programmable logic devices (PLDs), or the like, or a combination of such hardware devices. The local storage 413 comprises one or more storage devices utilized by the node to locally store configuration information for example, in a configuration data structure 414. The configuration information may include information regarding storage volumes and the QOS associated with each storage volume.

The cluster access adapter 412 comprises a plurality of ports adapted to couple node 208.1 to other nodes of cluster 202. In the illustrative aspect, Ethernet may be used as the clustering protocol and interconnect media, although it will be apparent to those skilled in the art that other types of protocols and interconnects may be utilized within the cluster architecture described herein. In alternate aspects where the network modules and storage modules are implemented on separate storage systems or computers, the cluster access adapter 412 is utilized by the network/storage module for communicating with other network/storage modules in the cluster 202.

Each node 208.1 is illustratively embodied as a dual processor storage system executing a storage operating system 406 (similar to 126, FIG. 1) that preferably implements a high-level module, such as a file system, to logically organize the information as a hierarchical structure of named directories and files at storage 212.1. However, it will be apparent to those of ordinary skill in the art that the node 208.1 may alternatively comprise a single or more than two processor systems. Illustratively, one processor 402A executes the functions of the network module on the node, while the other processor 402B executes the functions of the storage module.

The memory 404 illustratively comprises storage locations that are addressable by the processors and adapters for storing programmable instructions and data structures. The processor and adapters may, in turn, comprise processing elements and/or logic circuitry configured to execute the programmable instructions and manipulate the data structures. It will be apparent to those skilled in the art that other processing and memory means, including various computer readable media, may be used for storing and executing program instructions pertaining to the disclosure described herein.

The storage operating system 406 portions of which is typically resident in memory and executed by the processing elements, functionally organizes the node 208.1 by, inter alia, invoking storage operation in support of the storage service implemented by the node.

The network adapter 410 comprises a plurality of ports adapted to couple the node 208.1 to one or more clients 204.1/204.N over point-to-point links, wide area networks, virtual private networks implemented over a public network (Internet) or a shared local area network. The network adapter 410 thus may comprise the mechanical, electrical and signaling circuitry needed to connect the node to the network. Each client 204.1/204.N may communicate with the node over network 206 (FIG. 2A) by exchanging discrete frames or packets of data according to pre-defined protocols, such as TCP/IP.

The storage adapter 416 cooperates with the storage operating system 406 executing on the node 208.1 to access information requested by the clients. The information may be stored on any type of attached array of writable storage device media such as video tape, optical, DVD, magnetic tape, bubble memory, electronic random access memory, micro-electro mechanical and any other similar media adapted to store information, including data and parity information. However, as illustratively described herein, the information is preferably stored at storage device 212.1. The storage adapter 416 comprises a plurality of ports having I/O interface circuitry that couples to the storage devices over an I/O interconnect arrangement, such as a conventional high-performance, Fibre Channel link topology. The throughput from the storage adapter 416 is provided to the management console 118 during the resource monitoring step B304 of FIG. 3.

Operating System:

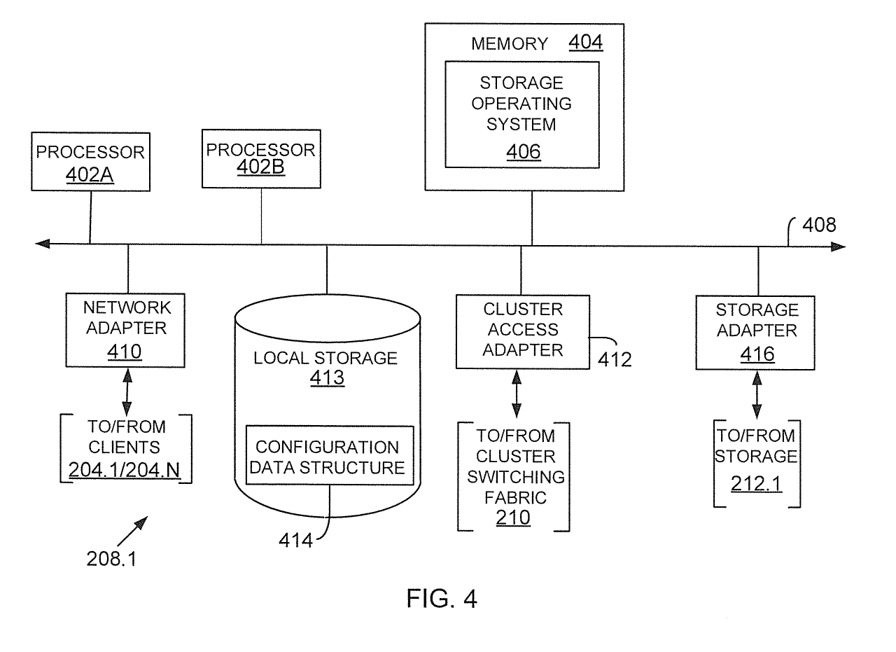

FIG. 5 illustrates a generic example of storage operating system 406 (or 126, FIG. 1) executed by node 208.1, according to one aspect of the present disclosure. The storage operating system 406 interfaces with the management console 118 and the performance manager 122 for providing performance data as well data regarding the different resources monitored by the management console 118, as described above.

In one example, storage operating system 406 may include several modules, or “layers” executed by one or both of storage module 214 and storage module 216. These layers include a file system manager 500 that keeps track of a directory structure (hierarchy) of the data stored in storage devices and manages read/write operation, i.e. executes read/write operation on storage in response to client 204.1/204.N requests.

Storage operating system 406 may also include a protocol layer 502 and an associated network access layer 506, to allow node 208.1 to communicate over a network with other systems, such as clients 204.1/204.N. Protocol layer 502 may implement one or more of various higher-level network protocols, such as NFS, CIFS, Hypertext Transfer Protocol (HTTP), TCP/IP and others.

Network access layer 506 may include one or more drivers, which implement one or more lower-level protocols to communicate over the network, such as Ethernet. Interactions between clients' and mass storage devices 212.1-212.3 (or 114) are illustrated schematically as a path, which illustrates the flow of data through storage operating system 406.

The storage operating system 406 may also include a storage access layer 504 and an associated storage driver layer 508 to allow storage module 216 to communicate with a storage device. The storage access layer 504 may implement a higher-level storage protocol, such as RAID (redundant array of inexpensive disks), while the storage driver layer 508 may implement a lower-level storage device access protocol, such as Fibre Channel or SCSI. The storage driver layer 508 may maintain various data structures (not shown) for storing information regarding storage volume, aggregate and various storage devices that is provided to the management console 118.

As used herein, the term “storage operating system” generally refers to the computer-executable code operable on a computer to perform a storage function that manages data access and may, in the case of a node 208.1, implement data access semantics of a general purpose operating system. The storage operating system can also be implemented as a microkernel, an application program operating over a general-purpose operating system, such as UNIX® or Windows XP®, or as a general-purpose operating system with configurable functionality, which is configured for storage applications as described herein.

In addition, it will be understood to those skilled in the art that the disclosure described herein may apply to any type of special-purpose (e.g., file server, filer or storage serving appliance) or general-purpose computer, including a standalone computer or portion thereof, embodied as or including a storage system. Moreover, the teachings of this disclosure can be adapted to a variety of storage system architectures including, but not limited to, a network-attached storage environment, a storage area network and a storage device directly-attached to a client or host computer. The term “storage system” should therefore be taken broadly to include such arrangements in addition to any subsystems configured to perform a storage function and associated with other equipment or systems. It should be noted that while this description is written in terms of a write any where file system, the teachings of the present disclosure may be utilized with any suitable file system, including a write in place file system.

Processing System:

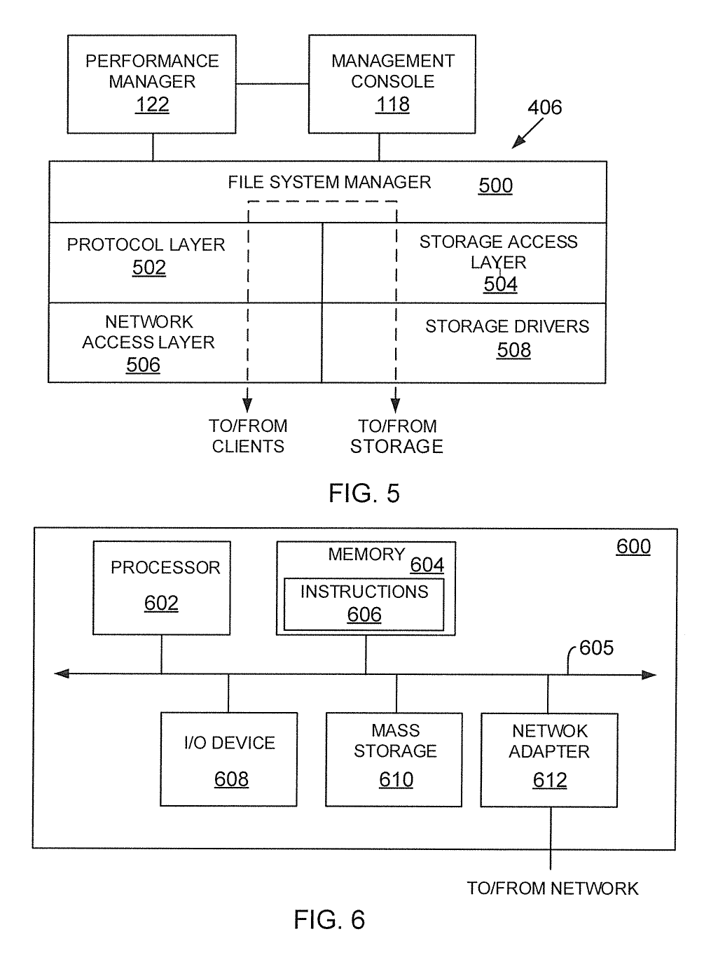

FIG. 6 is a high-level block diagram showing an example of the architecture of a processing system 600 that may be used according to one aspect. The processing system 600 can represent host system 102, management console 118, performance manager 122, clients 116, 204, or storage system 108. Note that certain standard and well-known components which are not germane to the present aspects are not shown in FIG. 6.

The processing system 600 includes one or more processor(s) 602 and memory 604, coupled to a bus system 605. The bus system 605 shown in FIG. 6 is an abstraction that represents any one or more separate physical buses and/or point-to-point connections, connected by appropriate bridges, adapters and/or controllers. The bus system 605, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The processor(s) 602 are the central processing units (CPUs) of the processing system 600 and, thus, control its overall operation. In certain aspects, the processors 602 accomplish this by executing software stored in memory 604. A processor 602 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 604 represents any form of random access memory (RAM), read-only memory (ROM), flash memory, or the like, or a combination of such devices. Memory 604 includes the main memory of the processing system 600. Instructions 606 implement the process steps of FIG. 3 described above may reside in and executed by processors 602 from memory 604.

Also connected to the processors 602 through the bus system 605 are one or more internal mass storage devices 610, and a network adapter 612. Internal mass storage devices 610 may be, or may include any conventional medium for storing large volumes of data in a non-volatile manner, such as one or more magnetic or optical based disks. The network adapter 612 provides the processing system 600 with the ability to communicate with remote devices (e.g., storage servers) over a network and may be, for example, an Ethernet adapter, a Fibre Channel adapter, or the like.

The processing system 600 also includes one or more input/output (I/O) devices 608 coupled to the bus system 605. The I/O devices 608 may include, for example, a display device, a keyboard, a mouse, etc.

Thus, a method and apparatus for efficiently monitoring resources of a networked storage environment have been described. Note that references throughout this specification to “one aspect” or “an aspect” mean that a particular feature, structure or characteristic described in connection with the aspect is included in at least one aspect of the present disclosure. Therefore, it is emphasized and should be appreciated that two or more references to “an aspect” or “one aspect” or “an alternative aspect” in various portions of this specification are not necessarily all referring to the same aspect. Furthermore, the particular features, structures or characteristics being referred to may be combined as suitable in one or more aspects of the disclosure, as will be recognized by those of ordinary skill in the art.

While the present disclosure is described above with respect to what is currently considered its preferred aspects, it is to be understood that the disclosure is not limited to that described above. To the contrary, the disclosure is intended to cover various modifications and equivalent arrangements within the spirit and scope of the appended claims.

What is claimed is:

1. A machine implemented method, comprising:
monitoring at a time interval a plurality of resources of a cluster of a networked storage environment having a plurality of nodes and storage devices for storing data on behalf of a plurality of users, where a processor of a management console monitors the plurality of resources;
retrieving performance data of a storage volume presented by one of the nodes of the cluster;
comparing the performance data with a threshold value to determine whether resources associated with the storage volume are being used;
increasing the time interval for monitoring the associated resources when the performance data continues to be consistently below the threshold value for a certain duration; and
decreasing the time interval for monitoring the associated resources when the performance data continues to be consistently above or equal to the threshold value for a certain duration.

2. The method of claim 1, wherein the performance data is a number of input/output requests per second (IOPS) processed by a node.

3. The method of claim 2, wherein when the number of IOPS are below the threshold value for the certain duration, then the time interval is increased.

4. The method of claim 2, wherein when the number of IOPS are above the threshold value for the certain duration, then the time interval is decreased.

5. The method of claim 1, wherein a performance console collects the performance data and the management console retrieves the performance data from the performance console to determine that the associated resources are being accessed.

6. The method of claim 1, wherein the plurality of resources are configured such that some of the plurality of resources are dedicated to users of a same geographical area.

7. The method of claim 1, wherein the management console monitors a virtual server, a logical unit number, storage device utilization, and amount of data transferred by an adapter of each of the nodes that communicate with storage devices within the cluster.

8. A non-transitory, machine readable medium having stored thereon instructions comprising machine executable code which when executed by a machine, causes the machine to:
monitor at a time interval a plurality of resources of a cluster of a networked storage environment having a plurality of nodes and storage devices for storing data on behalf of a plurality of users, where a processor of a management console monitors the plurality of resources;
retrieve performance data of a storage volume presented by one of the nodes of the cluster;
compare the performance data with a threshold value to determine whether resources associated with the storage volume are being used;
increase the time interval for monitoring the associated resources when the performance data continues to be consistently below the threshold value for a certain duration; and
decrease the time interval for monitoring the associated resources when the performance data continues to be consistently above or equal to the threshold value for a certain duration.

9. The non-transitory, storage medium of claim 8, wherein the performance data is a number of input/output requests per second (IOPS) processed by a node.

10. The non-transitory, storage medium of claim 9, wherein when the number of IOPS are below the threshold value for the certain duration, then the time interval is increased.

11. The non-transitory, storage medium of claim 9, wherein when the number of IOPS are above the threshold value for the certain duration, then the time interval is decreased.

12. The non-transitory, storage medium of claim 8, wherein a performance console collects the performance data and the management console retrieves the performance data from the performance console to determine that the associated resources are being accessed.

13. The non-transitory, storage medium of claim 8, wherein the plurality of resources are configured such that some of the plurality of resources are dedicated to users of a same geographical area.

14. The non-transitory, storage medium of claim 8, wherein the management console monitors a virtual server, a logical unit number, storage device utilization, and amount of data transferred by an adapter of each of the nodes that communicate with storage devices within the cluster.

15. A system, comprising:
a memory containing machine readable medium comprising machine executable code having stored thereon instructions; and a processor module for a management console coupled to the memory, the processor module configured to execute the machine executable code to:
monitor at a time interval a plurality of resources of a cluster of a networked storage environment having a plurality of nodes and storage devices for storing data on behalf of a plurality of users;
retrieve performance data of a storage volume presented by one of the nodes of the cluster;
compare the performance data with a threshold value to determine whether resources associated with the storage volume are being used;
increase the time interval for monitoring the associated resources when the performance data continues to be consistently below the threshold value for a certain duration; and
decrease the time interval for monitoring the associated resources when the performance data continues to be consistently above or equal to the threshold value for a certain duration.

16. The system of claim 15, wherein the performance data is a number of input/output requests per second (IOPS) processed by a node.

17. The system of claim 16, wherein when the number of IOPS are below the threshold value for the certain duration, then the time interval is increased.

18. The system of claim 16, wherein when the number of IOPS are above the threshold value for the certain duration, then the time interval is decreased.

19. The system of claim 15, wherein a performance console collects the performance data and the management console retrieves the performance data from the performance console to determine that the associated resources are being accessed.

20. The system of claim 15, wherein the plurality of resources are configured such that some of the plurality of resources are dedicated to users of a same geographical area.
